(19) United States
(12) Patent Application Publication
(10) Pub. No.: US 2020/0397007 A1
(43) Pub. Date: Dec. 24, 2020

(54) DEVICE FOR DEPOSITING DOUGH

(71) Applicant: Radie B.V., BC Culemborg (NL)

(72) Inventor: JOHANNES JOSEPHUS ANTONIUS VAN BLOKLAND, BG Laren (NL)

(21) Appl. No.: 16/904,787

(22) Filed: Jun. 18, 2020

(30) Foreign Application Priority Data
Jun. 21, 2019 (EP) 19181608.1

(51) Int. Cl. A21C 3/02

(52) U.S. Cl. CPC A21C 3/022

(57) ABSTRACT

The present invention relates to a device for depositing dough, comprising a supply conveyor for a dough sheet or dough products, guided over a path, said path comprising a nose bar that is translatable over a first distance, a transmission, for translating the nose bar, the transmission comprising a rod, rotatably coupled to a first rotatable arm at a first coupling point on the rod, rotatably coupled to a second rotatable arm at a second coupling point on the rod, rotatably coupled to the nose bar at a third coupling point on the rod, wherein the second coupling point is at a second distance from the first coupling point, the third coupling point being at third distance from the first coupling point; and the third distance is larger than the second distance; and a drive, for driving at least one of the first and/or the second rotatable arms.

### CROSS-REFERENCE TO RELATED APPLICATIONS

This application claims priority of European Patent Application Number 19181608.1, filed on Jun. 21, 2019 in European Patent Office, and herein incorporated by reference in its entirety.

### TECHNICAL FIELD

The present invention relates to a device for depositing dough, and in particular, for producing a dough laminate from a dough sheet.

### BACKGROUND

Devices for producing dough laminates are known in the art. One example is given in the European patent EP 2460410, disclosing a device for lapping dough. The device described in this patent has several advantages over the prior art, but it is mainly intended for lapping dough over large widths. In some configurations, there is little space available for installing a dough lapping device in a dough line, and may not always be a need for a large lapping device. In these cases, retracting systems may be applied, in particular reciprocate-retract systems. However, a demand for small sized devices and compact solution remains, possibly with a simple and robust construction and a minimal number of parts.

### SUMMARY

It is in particular, but evidently not limited for these applications, that the present invention aims to find a solution for. The invention does so by proposing a supply conveyor for a dough sheet, guided over a path, said path comprising a nose bar that is translatable over a first distance, a transmission, for translating the nose bar, the transmission comprising a rod, rotatably coupled to a first rotatable arm at a first coupling point on the rod, rotatably coupled to a second rotatable arm at a second coupling point on the rod, and rotatably coupled to the nose bar at a third coupling point on the rod, wherein the second coupling point is at a second distance from the first coupling point; the third coupling point being at third distance from the first coupling point; and the third distance is larger than the second distance; and a drive, for driving at least one of the first and/or the second rotatable arms.

In an embodiment, a plane through the axis of rotation of the first rotatable arm and the axis of rotation of the second rotatable arm is parallel to the plane in which the nose bar is movable. However, configurations wherein the axis of rotation of the first rotatable arm is higher or lower than the axis of rotation of the second rotatable arm are thinkable too.

In yet a further embodiment, the second arm is longer than the first arm. In a preferred embodiment of the present invention, the length of the rod and the two arms, and the locations of the rotatable connections are dimensioned such that the path of the third connection point is straight.

This can be obtained when the length of the first arm, the length of the second arm and the distance between the rotation point of the first arm and the second arm relate as 2:5:4, and the rod is twice as long as the second arm, and the second arm is coupled to the rod halfway to the rods length. In a particular embodiment, the first, second and third coupling points may be on a straight line. With this configuration, a compact and simple machine can be obtained. In particular, only three moving parts are required for obtaining the movement of the nose bar, being the first arm, the second arm and the rod.

In yet a further embodiment, the supply conveyor is guided over a path that also comprises a tail bar that is coupled to the nose bar at a distance of the nose bar, wherein the conveyor belt is zig-zagged around both bars, for keeping the total length of the path of the conveyor belt constant when the nose bar and tail bar are translated. With this construction, a constant tension on the belt can relatively easily be maintained. The construction further contributes to a simple and compact construction.

Preferably, a straight projection of the translation of the third coupling point on the plane through the axis of rotation of the first rotatable arm and the axis of rotation of the second rotatable arm extends outside the area between the axis of rotation of the first rotatable arm and the axis of rotation of the second rotatable arm, and preferably falls outside the area between the axis of rotation of the first rotatable arm and the axis of rotation of the second rotatable arm. This way, the nose bar moves mainly outside the area where the transmission is located, and a second conveyor, on which the laminated dough is to be placed, can be placed under the path of translation of the nose bar.

The nose bar may be translatable above a transporter, such as a transporter for baking trays or in particular above a second conveyor belt with a direction of conveyance parallel to or perpendicular to the direction of conveyance of the supply conveyor belt. Such second conveyor belt serves to receive the dough that is deposited by the first conveyor. The dough may be applied on the transporter in a laminated way, or dough products may be arranged in a predetermined way on the transporter.

The device may be provided with a drive for driving the supply conveyor belt, in particular arranged under the level of the nose bar. Providing the device with a drive leads to an autonomous device that can be placed autonomically in a dough line and requires no coupling with other parts of the dough line for being driven. The supply conveyor for a dough sheet may be guided over a path comprising an uphill trajectory. This uphill part can be placed at least partially under a preceding part of the dough line in order to transfer a dough sheet to be laminated.

The device according to the invention may have multiple purposes. It may be may be used for laminating a dough sheet, wherein multiple modes are thinkable. For that reason a retracting speed of the nose bar, a forward speed of the nose bar and a conveyance speed of the supply conveyor may be independently controllable.

In a simple way of use, the device according to the invention is operated with a constant speed of the supply conveyor. In those cases, the retracting speed of the nose bar may be higher than the forward speed. Such mode can be used for laminating dough, but also for placing separate dough products on a baking tray. It may also be beneficial when a retracting speed of the nose bar and a forward speed of the nose bar are equal. In those cases, the supply conveyor may be operated width an intermittent speed. In particular in those cases, a buffer for dough and more in particular for a dough sheet, may be arranged up stream of the supply conveyor. The device may also be provided with a dough cutter, for cutting dough on the supply conveyor, in a direction perpendicular to a direction of conveyance of the dough conveyor. Such cutter may be applied when the device according to the invention is to be used to position multiple dough pieces, in particular parts of a dough sheet, are to be deposited on a substrate in a roof tile manner.

### BRIEF DESCRIPTION OF THE DRAWINGS

The invention will now be elucidated into more detail with reference to the following figures. Herein:

FIG. 1 shows a first embodiment of a device according to the present invention; and

FIG. 2 shows a second embodiment of a device according to the present invention.

### DETAILED DESCRIPTION

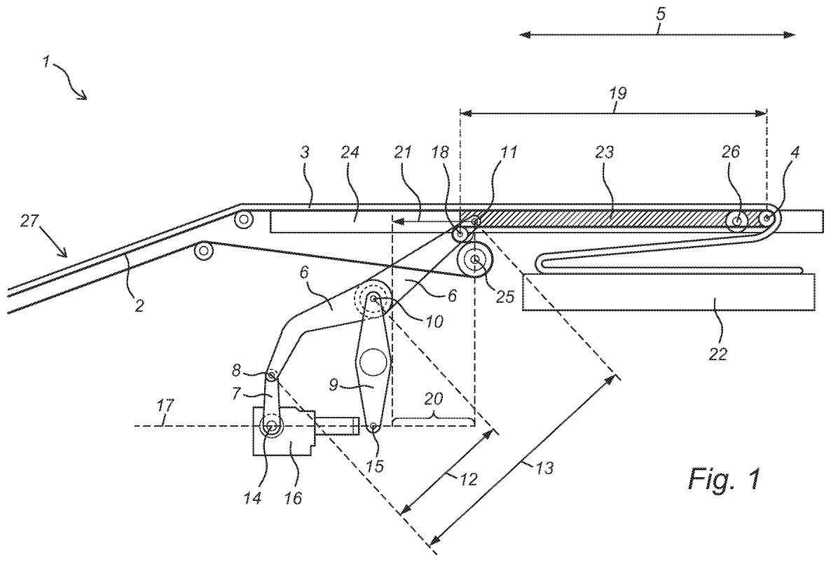

FIG. 1 shows a device 1 for laminating dough, comprising a supply conveyor 2 for a dough sheet 3, guided over a path, said path comprising a nose bar 4 that is translatable over a first distance 5, a transmission 6, 7, 8, 9, 10, for translating the nose bar 4, the transmission comprising a rod 6, rotatably coupled to a first rotatable arm 7 at a first coupling point 8 on the rod 6, rotatably coupled to a second rotatable arm 9 at a second coupling point 10 on the rod 6, rotatably coupled to the nose bar 4 at a third coupling point 11 on the rod 6, wherein the second coupling point 10 is at a second distance 12 from the first coupling point 8, the third coupling point 11 being at third distance 13 from the first coupling point 8; and the third distance 13 is larger than the second distance 12. The device also has a drive 16, for driving at least one of the first and/or the second rotatable arms 7, 9, either around rotation point 14 or 15. As visible in the figure, a plane 17 through the axis of rotation 8 of the first rotatable arm 7 and the axis of rotation 15 of the second rotatable arm 9 is parallel to the plane 5 in which the nose bar 4 is movable.

The supply conveyor 2 is guided over a path that also comprises a tail bar 18 that is coupled to the nose bar 4 at a distance 19 of the nose bar 4, wherein the conveyor belt is zig-zagged around both bars, for keeping the total length of the path of the conveyor belt 2 constant when the nose bar 4 and tail bar 18 are translated. A straight projection 20 of the translation 21 of the third coupling point 11 on the plane through the axis of rotation 14 of the first rotatable arm 7 and the axis of rotation 15 of the second rotatable arm 9 extends outside the area between the axis of rotation 14 of the first rotatable arm 7 and the axis of rotation 15 of the second rotatable arm 9.

The nose bar 4 is translatable above a second conveyor belt 22, with a direction of conveyance perpendicular to the direction of conveyance of the supply conveyor belt 2. The nose bar 4 is coupled to the rod 6 by means of a slide 23, that also carries the nose bar 4. The slide 23 bar is further guided by a rotational bearing 26 through a guide 24. The device further comprises a drive 25 for driving the supply conveyor belt. The supply conveyor 2 for a dough sheet is guided over a path comprising an uphill trajectory 27, which allows to transfer the dough sheet from a preceding processing device in the dough line to the laminating device according to the invention.

The device 1 according to the present invention forms a very compact system for depositing dough. The dough may be deposited on a substrate such as another conveyor, a baking tray or any other substrate. The dough may be a dough sheet or may comprise separate dough products. By driving at least one of the first or second rotatable arm 7, 9, the rod 6 is moved, and therewith the nose bar 4 of the device 1. The first and second arm 7, 9 may be chosen with different lengths, dimensioned such that the third coupling point 11 is moved along an essentially straight path. Such dimensions allow a third coupling point 11 without the necessity of further intermediate coupling parts, and furthermore, keep the mechanic forces that may cause vibrations the smallest.

The coupling of the rod 6 to the nose bar 4 at the third coupling point 11 may be a direct or indirect coupling. The rod 6 may be rotatably connected to or close to the nose bar 4, or by means of an interface, such as a sledge. Such sledge may further support a part of the supply conveyor belt 2.

In an embodiment, a plane through the axis of rotation of the first rotatable arm 7 and the axis of rotation of the second rotatable arm 9 is parallel to the plane in which the nose bar 4 is movable. However, configurations wherein the axis of rotation of the first rotatable arm 7 is higher or lower than the axis of rotation of the second rotatable arm 9 are thinkable too.

In yet a further embodiment, the second arm 9 is longer than the first arm 7. In a preferred embodiment of the present invention, the length of the rod 6 and the two arms 7 and 9, and the locations of the rotatable connections 14, 15 are dimensioned such that the path of the third connection point is straight. This can be obtained when the length of the first arm 7, the length of the second arm 9 and the distance between the rotation point of the first arm and the second arm 7, 9 relate as 2:5:4, and the rod 6 is twice as long as the second arm 9, and the second arm 9 is coupled to the rod 6 halfway to the rod's length. In a particular embodiment, the first, second and third coupling points 8, 10, 11 may be on a straight line. With this configuration, a compact and simple machine can be obtained. In particular, only three moving parts are required for obtaining the movement of the nose bar 4, being the first arm 7, the second arm 9 and the rod 6.

The nose bar 4 may be translatable above a transporter, such as a transporter for baking trays or in particular above a second conveyor belt with a direction of conveyance parallel to or perpendicular to the direction of conveyance of the supply conveyor belt. Such second conveyor belt serves to receive the dough that is deposited by the first conveyor. The dough may be applied on the transporter in a laminated way, or dough products may be arranged in a predetermined way on the transporter.

The device 1 may be provided with a drive 16 for driving the supply conveyor belt 2, in particular arranged under the level of the nose bar 4. Providing the device 1 with a drive 16 leads to an autonomous device that can be placed autonomically in a dough line and requires no coupling with other parts of the dough line for being driven. The supply conveyor 2 for a dough sheet may be guided over a path comprising an uphill trajectory 27. This uphill part can be placed at least partially under a preceding part of the dough line in order to transfer a dough sheet to be laminated.

The device 1 according to the invention may have multiple purposes. It may be may be used for laminating a dough sheet, wherein multiple modes are thinkable. For that reason a retracting speed of the nose bar 4, a forward speed of the nose bar 4 and a conveyance speed of the supply conveyor 2 may be independently controllable.

In a simple way of use, the device 1 according to the invention is operated with a constant speed of the supply conveyor 2. In those cases, the retracting speed of the nose bar 4 may be higher than the forward speed. Such mode can be used for laminating dough, but also for placing separate dough products on a baking tray. It may also be beneficial when a retracting speed of the nose bar 4 and a forward speed of the nose bar 4 are equal. In those cases, the supply conveyor 2 may be operated width an intermittent speed. In particular in those cases, a buffer for dough and more in particular for a dough sheet, may be arranged up stream of the supply conveyor. The device 1 may also be provided with a dough cutter, for cutting dough on the supply conveyor 2, in a direction perpendicular to a direction of conveyance of the dough conveyor. Such cutter may be applied when the device 1 according to the invention is to be used to position multiple dough pieces, in particular parts of a dough sheet, are to be deposited on a substrate in a roof tile manner.

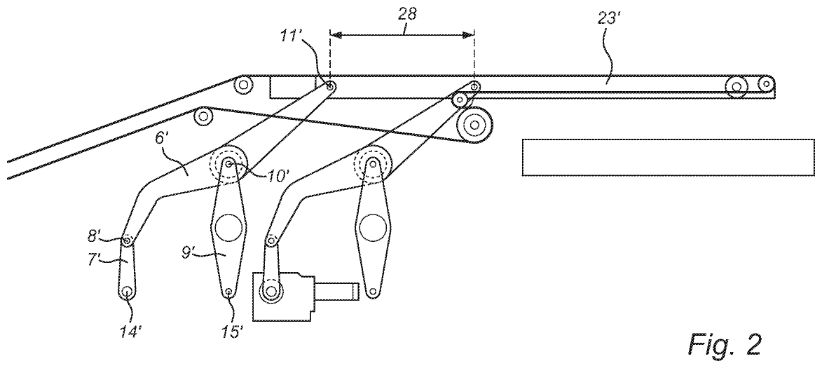

FIG. 2 shows an alternative embodiment, wherein for reasons of readability only references are indicated that differ from FIG. 1. Instead of a rotational bearing 26 and a guide 24, the slide 23′ is supported by a second rod 6′ at a distance 28 from the coupling with the rod 6′, rotatably coupled to a rotatable arm 7′ at a coupling point 8′ on the rod 6′, rotatably coupled to a rotatable arm 9′ at a coupling point 10′ on the rod 6′, rotatably coupled to the nose bar 4 at a coupling point 11′ on the rod 6′. The two parallel transmissions take away the need for the guide 24 in the embodiment of FIG. 1, and offer the advantage of less protruding device-parts around the nose-bar 4.

The alternative embodiment include additional transmission that includes the second rod 6′ which is rotatably coupled to the rotatable arm 7′ at the coupling point 8′ on the rod 6′, rotatably coupled to the rotatable arm 9′ at the coupling point 10′ on the rod 6′, and rotatably coupled to the nose bar 4 at the coupling point 11′ on the additional rod 6′. The additional transmission is coupled to the nose bar at a mutual horizontal distance. The additional transmission may be a dummy transmission not driven by a drive.

What is claimed is:

1. A device for depositing dough, comprising:
a supply conveyor for a dough sheet, guided over a path;
a nose bar that is position on the path and is translatable over a first distance;
a transmission for translating the nose bar, the transmission comprising a rod which is rotatably coupled to a first rotatable arm at a first coupling point on the rod, rotatably coupled to a second rotatable arm at a second coupling point on the rod, and rotatably coupled to the nose bar at a third coupling point on the rod, wherein:
the second coupling point is at a second distance from the first coupling point;
the third coupling point being at a third distance from the first coupling point; and
the third distance is larger than the second distance; and
a drive for driving at least one of the first and/or the second rotatable arms.

2. The device according to claim 1, wherein a plane through an axis of a rotation of the first rotatable arm and an axis of a rotation of the second rotatable arm is parallel to the plane in which the nose bar is movable.

3. The device according to claim 1, wherein lengths of the rod and the first and second rotatable arms, and locations of rotation points of the first and second arms are dimensioned such that the path of the third connection point is straight.

4. The device according to claim 1, wherein a length of the first rotatable arm, a length of the second rotatable arm and a distance between the rotation point of the first rotatable arm and the second rotatable arm relate as 2:5:4, and wherein the rod is twice as long as the second rotatable arm, and the second rotatable arm is coupled to the rod halfway to a length of the rod.

5. The device according to claim 1, wherein the supply conveyor is guided over a path that comprises a tail bar that is coupled to the nose bar at a distance of the nose bar, wherein the conveyor belt is zig-zagged around both the tail and node bars, for keeping the total length of the path of the conveyor belt constant when the nose bar and tail bar are translated.

6. The device according to claim 1, wherein a straight projection of the translation of the third coupling point on the plane through an axis of rotation of the first rotatable arm and an axis of rotation of the second rotatable arm extends outside an area between the axis of rotation of the first rotatable arm and the axis of rotation of the second rotatable arm, and falls outside the area between the axis of rotation of the first rotatable arm and the axis of rotation of the second rotatable arm.

7. The device according to claim 1, wherein the nose bar is translatable above a transporter, including a carrier for baking trays or a second conveyor belt, with a direction of conveyance parallel or perpendicular to a direction of conveyance of the supply conveyor belt.

8. The device according to claim 1, further comprising a drive for driving a supply conveyor belt arranged under the level of the nose bar.

9. The device according to claim 1, wherein the supply conveyor for a dough sheet is guided over a path comprising an uphill trajectory.

10. The device according to claim 1, wherein the transmission is a first transmission, the device further comprising a second transmission, wherein the first transmission and the second transmission are coupled to the nose bar at a mutual horizontal distance, wherein at least one of the first and second transmissions comprises a drive, and in particular wherein the other transmission is a dummy.

11. The device according to claim 1, wherein the supply conveyor is configured to be operated with a constant of a supply conveyor belt speed.

12. The device according to claim 1, wherein a retracting speed of the nose bar, a forward speed of the nose bar and a conveyance speed of the supply conveyor are independently controllable.

13. The device according to claim 1, further comprising a buffer for a dough sheet, arranged up stream of the supply conveyor.

14. The device according to claim 1, further comprising a dough cutter, for cutting dough on the supply conveyor, in a direction perpendicular to a direction of conveyance of the supply conveyor.

15. The device according to claim 1, further comprising an additional transmission coupled to the nose bar at a mutual horizontal distance, wherein the additional transmission comprises an additional rod which is rotatably coupled to an additional first rotatable arm at an additional first coupling point on the additional rod, rotatably coupled to an additional second rotatable arm at an additional second coupling point on the additional rod, and rotatably coupled to the nose bar at an additional third coupling point on the additional rod, and wherein the additional transmission is a dummy.
